(19) United States
(12) Patent Application Publication
(10) Pub. No.: US 2006/0105086 A1
(43) Pub. Date: May 18, 2006

(54) Device and method for absorbing excess fat from food

(76) Inventor: David Berg, White Lake, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/253,967

(22) Filed: Oct. 19, 2005

Related U.S. Application Data
(60) Provisional application No. 60/627,443, filed on Nov. 12, 2004.

(51) Int. Cl. A23C 15/14

(52) U.S. Cl. 426/417

(57) ABSTRACT

A device for removing excess fat from food includes a base with a first surface and a cooperating member with a second surface. A removable and replaceable fat absorbing sheet is placed on the first surface, a portion of food is placed on the sheet, and another sheet is positioned between the portion of food and the second surface. The surfaces are moved to an engaged position such that the portion of food is squeezed and excess fat is absorbed by the sheets.

### REFERENCE TO RELATED APPLICATION

This application claims priority from U.S. Provisional Patent Application Ser. No. 60/627,443, filed Nov. 12, 2004, the entire content of which is incorporated herein by reference.

### FIELD OF THE INVENTION

The present invention relates generally to devices and methods for absorbing excess fat from food.

### BACKGROUND OF THE INVENTION

Nutritionists and dieticians agree that reducing the amount of fat in a person's diet is beneficial for weight control and health reasons. This has led to an explosion in the availability of reduced fat and low fat foods. However, many people still like to eat traditional higher fat foods such as grilled meat, pizza, fried foods and other oil-containing foods. Often, a significant portion of the fat and oil in these foods is at or near the surface of the foods and may be drained or absorbed from the foods to reduce their fat content. It is known to place fat-containing food products on drain racks or on absorptive material, such as paper towels, to drain or absorb some of the excess fat. However, there remains a need for a device and method for removing excess fat from foods.

### SUMMARY OF THE INVENTION

The present invention provides a device for removing excess fat from a portion of food. The device includes a base having a first surface and a cooperating member having a second surface. The cooperating member has an open position wherein the second surface is spaced from the first surface and an engaged position wherein the second surface is closer to the first surface and directed toward this first surface. The device also includes a plurality of removable and replaceable fat-absorbing sheets. Each sheet has a food-contacting face and an opposed back face. The sheets have a use position wherein the back face is disposed against the first surface of the base or the second surface of the cooperating member. One of the sheets is placed in the use position on the base and another sheet is placed in the use position on the cooperating member. A portion of food is positioned on the food-contacting face of the sheet on the base and the cooperating member is moved from the open position to the engaged position such that the portion of food is squeezed between the food-contacting faces of the first and second sheets and excess fat is removed from the portion of food.

In some embodiments of the present invention, the base and/or cooperating member includes a compressible element defining the surface such that the surface and the sheet disposed thereon at least partially conform to the portion of food when the cooperating member is in the engaged position. The compressible member may be a body of foam, a flexible membrane, or other compressible elements known to those of skill in the art, and may have a cleanable cover. In some embodiments, the fat-absorbing sheets each comprise an absorbent layer having a nonstick coating on the food-contacting face. Certain embodiments also include a backing layer, while other embodiments may replace the nonstick coating with a nonstick layer, which may be perforated to allow the passage of liquid therethrough.

Further embodiments of the present invention include a vibrating unit operable to vibrate at least a portion of the device for aiding in the extraction of excess fat from the portion of food. The vibrating unit may be disposed in the base and/or cooperating member. The device may further include a timing unit interconnected with the vibration unit operable to engage the vibrating unit for a predetermined period of time. Yet other embodiments of the device may include a biasing element operable to bias the cooperating member towards the base so as to squeeze the portion of food.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a perspective view of a device for absorbing excess fat from food according to one embodiment of the invention;

FIG. 2 is a cross sectional view of the device of FIG. 1, with the device open;

FIG. 3 is a cross sectional view with the device closed;

FIG. 4 is a diagram illustrating one approach to connecting components of the present invention;

FIG. 5 is a perspective view of another embodiment of a device according to the present invention;

FIG. 6 is a cross sectional view of an alternative embodiment of a device according to the present invention;

FIG. 7 is a cross sectional view of yet another alternative embodiment of a device according to the present invention;

FIG. 8 is a cross sectional view of a further embodiment of a device according to the present invention;

FIG. 9 is another view of the device of FIG. 8;

FIG. 10 is a cross sectional view of yet a further embodiment of a device according to the present invention;

FIG. 11 is a perspective view of an embodiment of the present invention with an optional dispensing portion;

FIG. 12 is a cross sectional view of part of FIG. 11, taken along lines 12-12; and

FIG. 13 is a cross sectional view of one embodiment of a fat absorbing sheet for use with the present invention.

### DETAILED DESCRIPTION OF THE PREFERRED EMBODIMENTS

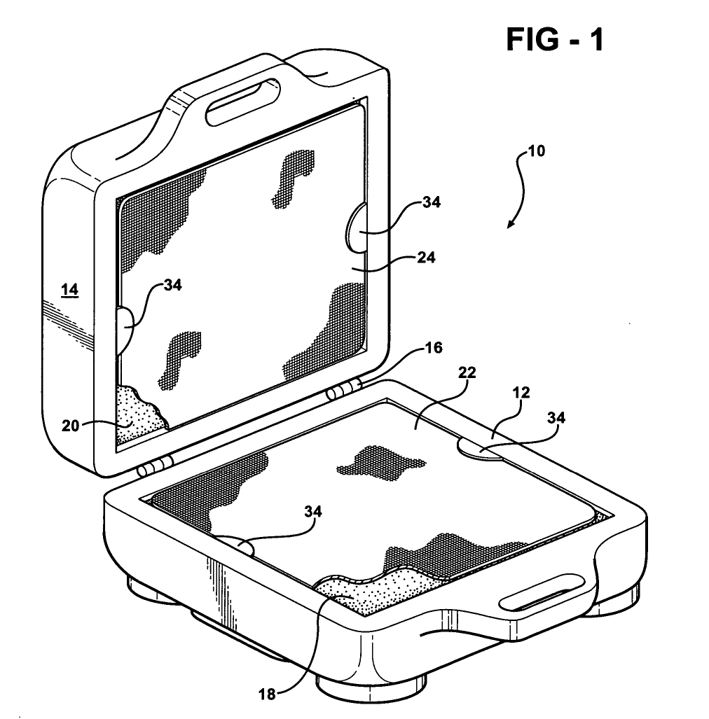

The present invention provides a device and method for removing excess fat from a portion of food. Various views of the various embodiments of the present invention are shown in FIGS. 1-13. A preferred embodiment of a device according to the present invention includes a base, a cooperating member, and a plurality of fat-absorbing sheets that work together to squeeze and remove excess fat from the portion of food.

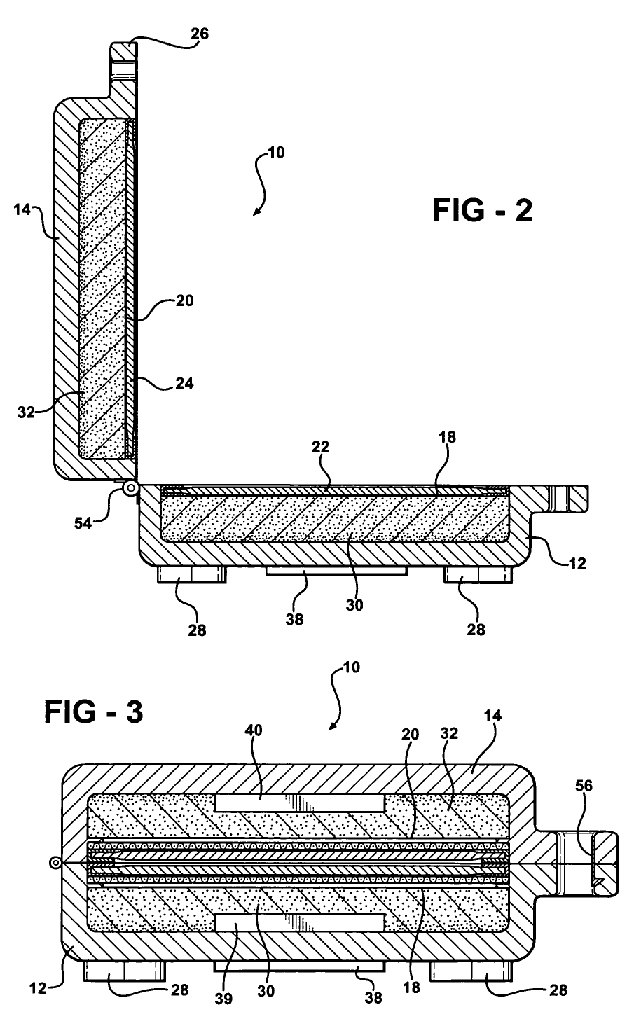

Referring to FIG. 1, a first embodiment of a device 10 according to the present invention has a base 12 and a cooperating member 14 that are hingedly interconnected by hinges 16. FIG. 1 shows the cooperating member 14 in an open position where it is pivoted away from the base 12. FIG. 2 shows a cross sectional view of the device 10 with the cooperating member 14 in an open position, and FIG. 3 shows a cross sectional view with the cooperating member 14 in a closed position. The base includes a first surface 18 and the cooperating member includes a second surface 20. In the open position, shown in FIG. 1, the first surface 18 and second surface 20 are spaced apart, as the cooperating member 14 is pivoted away from the base 12.

The device according to the present invention also includes a plurality of removable and replaceable fat-absorbing sheets. A first sheet 22 is shown disposed on the first surface 18 and a second sheet 24 is shown disposed on the second surface 20. The sheets 22 and 24 are shown cut away in FIG. 1 such that the first surface 18 and second surface 20 are visible. Each sheet has a back face disposed against the surface of the base 18 or cooperating member 20 and an opposed food-contacting face, which is visible in FIG. 1. In use, a portion of food is placed on the food-contacting face of the sheet 22 and the cooperating member 14 is moved to an engaged position wherein the second face 20 is directed toward the first face 18, and the portion of food is squeezed between the sheets 22 and 24 such that excess fat is absorbed into the sheets.

As shown in FIG. 1, the cooperating member 20 may have a handle 26 for assisting in moving it between the open and engaged positions. The base 12 may include a plurality of feet 28 for contacting a support surface on which the device 10 is placed to be used. The faces 18 and 20 of the base 12 and cooperating member 14 may be rigid and formed of a solid or mesh metal or plastic, or take other forms, but are preferably each conformable such that when the cooperating member 14 is in the engaged position the faces 18 and 20 and sheets 22 and 24 at least partially conform to the food being squeezed. In the embodiment of FIGS. 1-3, the base 12 and cooperating member 14 each have recesses that receive a body of foam or foam-like compressible material 30 and 32, respectively. The body of material may be an open or closed cell foam, but preferably is has a cleanable surface. As such, it may have a skin or covering, either as part of the foam body or as a separate cover, that provides a smooth or textured cleanable surface. The skin or covering may be only on the faces 18 or 20, or may be on all sides of the bodies of conformable material 30 and 32. The bodies of material may be removable from the base 12 and cooperating member 14, or may be permanently attached and/or integrally formed therewith. The bodies of material preferably conform to a food object placed between them so as to enhance the absorption of fat by the sheets. An alternative approach to providing conformable faces to the base and/or cooperating member are to have an air-containing element, which may conform to the portion of food. The element may be inflatable and deflatable to adjust the conformability of the element. The conformable bodies of material may also be changeable such that soft versions may be used with some food items and stiffer versions are used with other food items.

Referring again to FIGS. 1-3, the illustrated absorbent sheets are disposed only on the faces 18 and 20 of the base 12 and member 14. They are retained in position by retainers 34, as illustrated in FIG. 1. Retainers 34 are an optional feature, and may take a number of other forms. It should be noted that the relative thicknesses and dimensions of the various parts of the present invention are shown for illustrative purposes only, and are not limiting on the embodiments of the present invention. In FIGS. 2 and 3 the foam inserts 30 and 32 and the sheets 22 and 24 are both shown as very thick, but either or both may be much thinner.

Some embodiments of the present invention include a vibration unit for vibrating the absorbing sheets and/or the portion of food so as to assist in its extraction of excess fat from the portion of food. As known to those of skill in the art, the vibration unit may take a variety of forms. For example, the vibration unit may be piezoelectric or mechanical in nature, as well as other designs. It may be electrically powered, either AC, DC or battery, or may be mechanical, requiring winding or other approaches to storing energy. FIGS. 2 and 3 illustrate one embodiment of a vibration unit 38 attached to the underside of the base 12. The vibration unit 38 may be mechanical or electrical and is operable to vibrate the base 12. A second vibration unit may be provided in the cooperating member 14. The vibration units may also be positioned differently than shown, so as to improve the vibration transmission to the sheets 20 and 22 and the portion of food. For example, the vibration unit may be embedded in the foam 30 as shown at 39, shown only in FIG. 3. A vibration unit 40, shown only in FIG. 3, may be provided in or on the cooperating member 14 instead of or in addition to the units 38 or 39.

In some embodiments of the present invention, a timing unit is provided that is operable to engage the vibration unit for a predetermined period of time. In use, a portion of food is placed on the sheet 22, the cooperating member 14 is moved to the engaged position, and the vibration unit is operated for a period of time to assist in removal of excess fat. An indicator, such as an alarm or light, may indicate when the period of time is complete and the food may be removed. The start of the vibration cycle may be triggered by closing the cooperating member, by operating a switch, or by other means. The vibration unit may also operate as long as the cooperating member is closed, or only when a food object is being squeezed, as sensed by a pressure sensor.

The vibration unit may be operable to vibrate the device, or parts of the device, at low, medium, or high frequencies, or a combination of frequencies, so as to best remove the fat from the portion of food. The vibration frequencies could be as low as subsonic or as high as ultrasonic. In embodiments using an ultrasonic source, the source is preferably very close to the surface on which the portion of food will be placed, since ultrasonic waves may have limited range. Different frequencies may also be utilized for different food types and one or more vibration units may be used to create the different frequencies. For example, one frequency or combination of frequencies may be used for high density foods, such as meat, while a different frequency or combination of frequencies may be used for low density foods. Different buttons may be used for different modes. Alternatively, the vibration unit may vary the frequency through a range, either continuously or via discrete steps, during operating so that the portion of food is exposed to the range of frequencies. The amplitude of the vibration supplied may also range from low to high. Different amplitudes may be used for different food types, or the vibration amplitude may vary during operation.

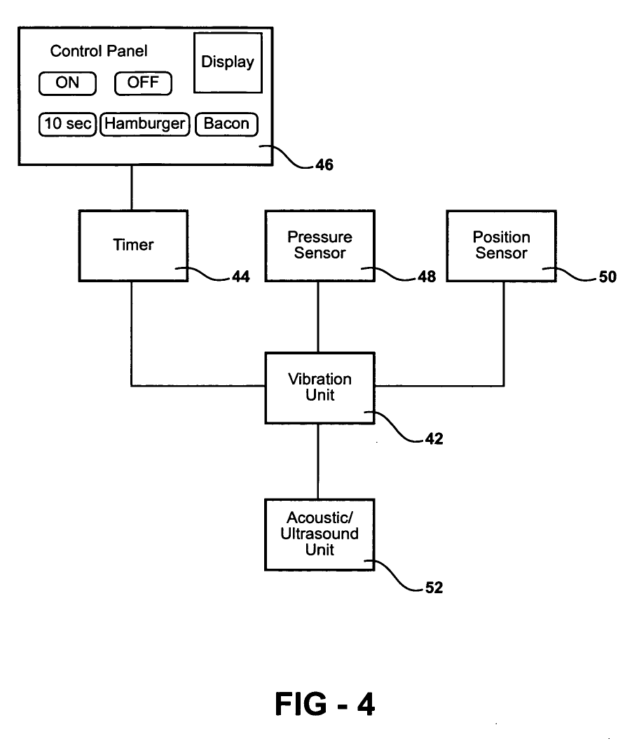

FIG. 4 provides a diagram for how the vibration unit and other components are interconnected, though other approaches may also be used. As shown, the vibration unit 42 is in communication with a timer 44, which is in communication with a control panel 46. The control panel may have a variety of controls and/or a display. For example, buttons may be provided for turning the unit on and off, for activating it for a set period of time, or for running a program appropriate for a particular food item. The display may provide information on the mode or time remaining, or other information. The vibration unit 42 is also shown in communication with a pressure sensor 48. The pressure sensor may take a variety of forms, such as sensing compression of the foam. The device according to the present invention may be operable only when pressure is sensed, or the mode or time may be adjusted based on pressure, or pressure may not be a factor and the sensor is eliminated. A position sensor 50 is also illustrated. The position sensor may sense the position of the cooperating member relative to the base so that the vibration unit only operates when the device is closed. An acoustic or ultrasound unit 52 is shown in communication with the vibration unit. As discussed above, the vibration unit may operate at any frequency. A second unit may be provided for certain frequencies. Other types of energy may be applied to the food item, such as microwave energy, ultraviolet light, or heat using appropriate sources.

It should be noted that a when food object is “squeezed”, the preferred pressure may vary from very light to heavy, depending on the food object. The device 10 may also include a biasing member, such as spring 54, that biases the cooperating member 14 towards the base 12. The biasing member may take the form of a spring that biases the cooperating member 14 downwardly. It may also take the form of a clasp 56 that pulls downwardly on the cooperating member 14 when it is in the engaged position. The biasing member may be selectively operable or continuously operable.

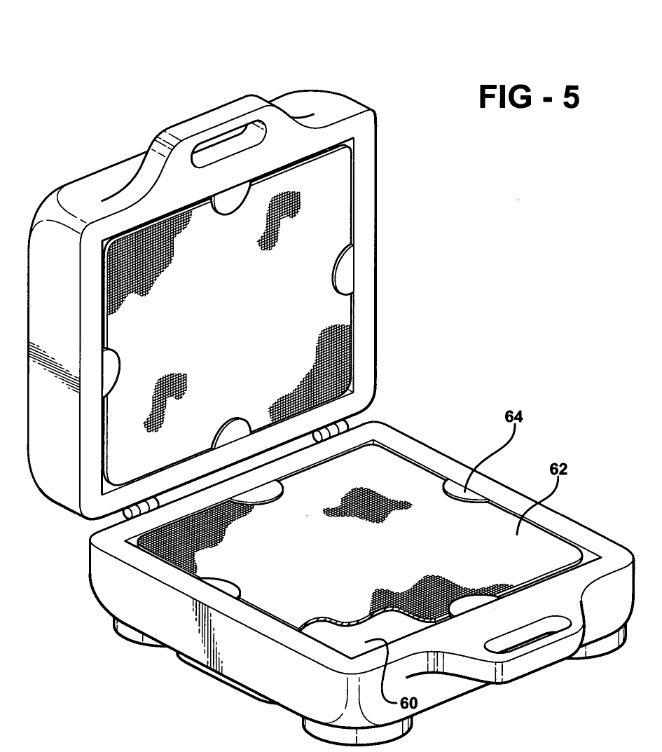

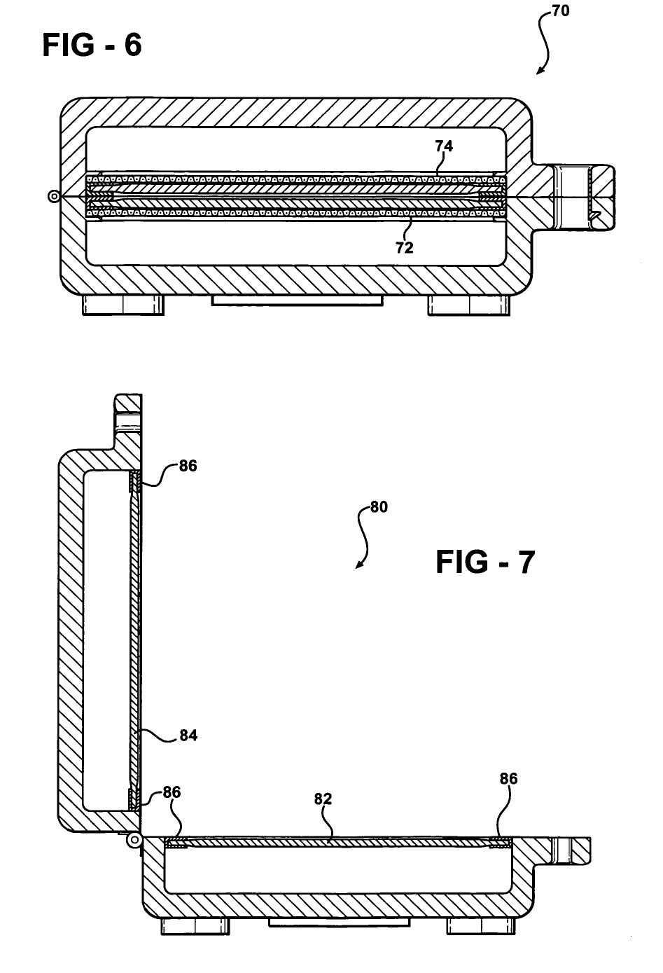

Turning now to FIGS. 5-10, several versions of the faces of the base or cooperating member are illustrated. FIG. 5 illustrates the inner surface of the base or cooperating member with a solid plate 60 with a fat-absorbing sheet 62 positioned thereon. As illustrated, spring clips 64 may be provided for retaining the sheet 62 in the use position. As will be clear to those of skill in the art, other retaining means may be used. FIG. 6 illustrates a cross section view of an embodiment of a device 70 with flexible membranes or grids 72 and 74 defining the inner surfaces of the base and cooperating member. These membranes or grids 72 and 74 form a trampoline-like surface such that they can flex when a food item is placed between them. The absorbent sheets are positioned on the membranes or grids 72 and 74, as shown. The membranes or grids 72 and 74 may be metal or plastic and may be smooth, perforated or a mesh, like a screen. They are preferably removable and/or cleanable.

FIG. 7 illustrates an embodiment of the device 80 wherein the fat-absorbing sheets 82 and 84 are each supported by multiple clips 86 so as to stretch and form a trampoline-like surface. The base or cooperating member may be hollow underneath, as shown, or may have a cooperating membrane for supporting the sheet.

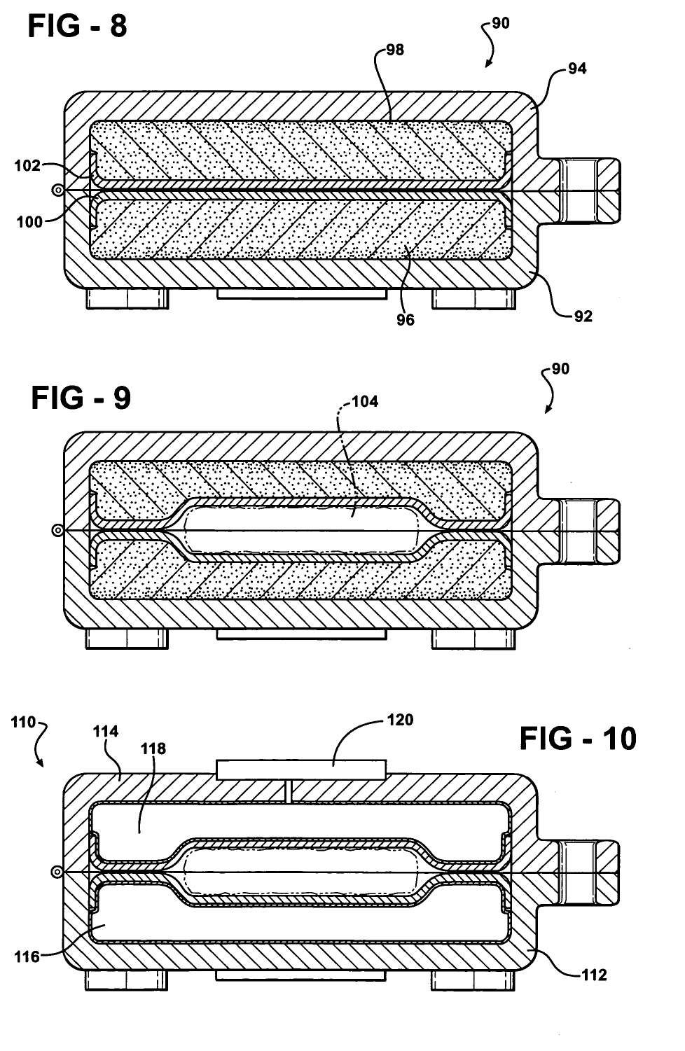

FIG. 8 illustrates yet another embodiment of a device 90 for absorbing excess fat from a food item. The device 90 has a base 92 and a cooperating member 94, each with foam inserts 96 and 98. Unlike the earlier embodiments, the fat absorbing sheets 100 and 102 wrap partially around the foam inserts. This may hold the sheets in place, or separate retainers may be provided. FIG. 9 illustrates the device with a food item 104 squeezed between the sheets.

FIG. 10 illustrates a further embodiment of a device 110 wherein base 112 has an air-filled insert 116 and the cooperating member 114 has an inflatable insert 118. A compressor or air pump 120 is in fluid communication with the inflatable insert 118 and inflates it to conform to the food item. The inflatable insert 118 and insert 116 may be traded, or both may be inflatable. In some versions, the compressor or air pump can serve as the vibration unit, or assist in extracting fat by providing pulses or air. Alternatively, the air pump can be used without a vibration unit with the pressurizing or pressure pulses assisting in fat extraction. The air pump can be used to set the volume of the insert 118 prior to use, or may inflate the insert 118 after the device is closed. Air may then be removed before or after the device is opened.

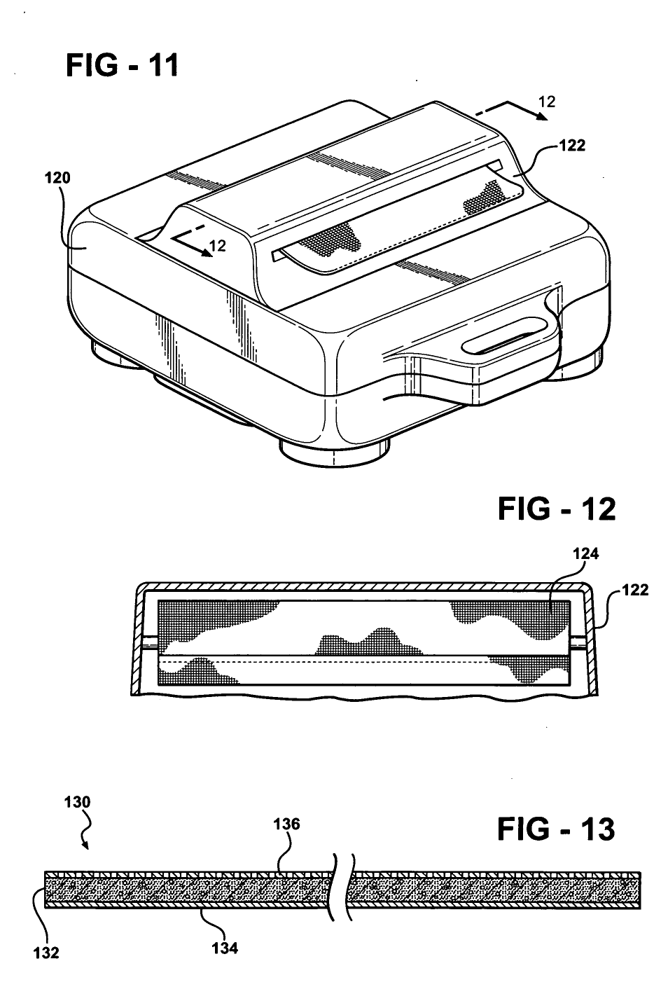

FIG. 11 shows a view of a preferred alternative embodiment of the device wherein the cooperating member 120 has an integrated roll support 122. FIG. 12 shows a cross section of the roll support 122 with a roll 124 supported therein. In this embodiment, the roll 124 is a roll formed of a plurality of unused fat-absorbing sheets with perforations between each sheet. In use, a sheet is unrolled from the roll 124 and placed on the first or second surface of the device. An additional sheet is unrolled and placed on the other surface. Alternatively, the cooperating member 120 may include a holder for individual sheets in a stack, as may the base.

Turning now to FIG. 13, a cross-sectional view of one embodiment of a fat-absorbing sheet is shown at 130. In some versions, the sheet 130 includes an absorbent layer 132 operable to absorb fat from a portion of food and a backing layer 134. The backing layer 134 may be generally impervious to liquids so as to prevent passage of liquids from the absorbent layer 132 to the surface of the base or cooperating member. The absorbent sheet may also include a nonstick layer 136 so as to prevent the sheet 130 from sticking to the food. The nonstick layer may be perforated or otherwise treated so as to allow passage of excess fat therethrough into the absorption layer 132. Alternatively, the nonstick layer 136 may be replaced with a nonstick coating on the absorption layer 132. Likewise, the backing layer 134 may be replace with a backing coating, which may block liquid.

As will be clear to those of skill in the art, the sheet 130 may be made in several different ways, and the first and second sheet do not necessarily have to be formed in the same way. For example, the sheet placed on the base may be thicker and more absorptive than the sheet placed on the cooperating member since fat will tend to be squeezed downwardly. Likewise, the surfaces of the base and cooperating member may both be rigid or conformable, or a combination. A user may choose to not use a sheet on both the upper surface and the lower surface but instead turn the food over and squeeze the food again. The fat-absorbing sheets may also be used without the base and cooperating member such as by placing the fat-absorbing sheet under a portion of food on a plate or serving dish.

The sheets may take a variety of shapes and forms other than illustrated. For example, the sheets may be square, rectangular, round, oval, or complex in shape. They may have tabs, pockets, or other attachment means to assist in retaining the sheets in the device. As a further alternative, the sheets may take the form of a bag that receives the portion of food, with the bag being placed in the device to be squeezed. The device may also have different shapes and designs than illustrated. For example, it may be square, rectangular, round, oval or other shapes. As yet further alternatives, the pads may be thick enough to conform to the portion of food, without the surfaces of the base and/or cooperating member being conformable. As one example, an upper and/or lower pad may have a foam insert in the pad, or have air pockets or other means to allow it to conform to the food. Another alternative is that the sheets are provided large enough that a single sheet may be folded over a portion of food, rather than using two sheets. Also, the sheets are not required to be attached to the surfaces of the base and cooperating member. Instead, a sheet may be placed on one surface and another sheet placed on top of the food, or the same sheet or bag covering the top. A two sided absorbent sheet may also be provided so that it can be turned over or folded, and reused. A further preferred version of the present invention has a stack of absorbent sheets with one stack provided on the surface of the base and another on the surface of the cooperating member. The outermost sheet contacts the food item and absorbs fat, and then is peeled off and disposed of. Each sheet preferably has a backing layer that blocks fat from passing to the next sheet. Adhesive or other retaining means may be used to retain the sheets in a stack.

As will be clear to those of skill in the art, the herein described embodiments of the present invention may be altered in various ways without departing from the scope or teaching of the present invention.

I claim:

1. A device for removing excess fat from a portion of food, the device comprising:
a base having a first surface;
a cooperating member having a second surface, the cooperating member having an open position wherein the second surface is spaced from the first surface and an engaged position wherein the second surface is closer to the first surface and directed toward the first surface; and
a plurality of removable and replaceable fat absorbing sheets, each sheet having a food contacting face and an opposed back face, the sheets having a use position wherein the back face is disposed against the first surface of the base or the second surface of the cooperating member;
wherein a first one of the sheets is placed in the use position on the base, a portion of food is positioned on the food contacting face of the first sheet, a second one of the sheets is placed in the use position between the portion of food and the second surface of the cooperating member, and the cooperating member is moved from the open position to the engaged position such that the portion of food is squeezed between the food contacting faces of the first and second sheets and excess fat is removed from the portion of food.

2. The device according to claim 1, wherein the base includes a compressible element defining the first surface such that the first surface and the first sheet at least partially conform to the portion of food when the cooperating member is in the engaged position.

3. The device according to claim 2, wherein the compressible member is selected from the group consisting of a body of foam, a flexible membrane, and an inflatable member.

4. The device according to claim 1, wherein the cooperating member includes a compressible element defining the second surface such that the second surface and the second sheet at least partially conform to the portion of food when the cooperating member is in the engaged position, the compressible member being selected from the group consisting of a body of foam, a flexible membrane, and an inflatable member.

5. The device according to claim 1, wherein the fat absorbing sheets each comprise an absorbent layer having a non-stick coating on the food contacting face.

6. The device according to claim 5, wherein the fat absorbing sheets each further comprise a backing layer defining the back face, the backing layer generally preventing the passage of liquids therethrough.

7. The device according to claim 1, wherein the fat absorbing sheets each comprise an absorbent layer and a non-stick layer, the non-stick layer defining the food contacting face.

8. The device according to claim 7, wherein the fat absorbing sheets each further comprise a backing layer defining the back face, the backing layer generally preventing the passage of liquids therethrough.

9. The device according to claim 1, wherein the first and second sheets are portions of a continuous sheet that is folded to surround the portion of food.

10. The device according to claim 1, further comprising a roll for storing unused ones of the fat absorbing sheets, the roll being supported on the cooperating member.

11. The device according to claim 1, wherein the cooperating member is hingedly interconnected with the base.

12. The device according to claim 1, further comprising a vibration unit operable to vibrate the first surface of the base and/or the second surface of the cooperating member.

13. The device according to claim 12, further comprising a timer operable to engage the vibration unit for a predetermined period of time.

14. The device according to claim 12, further comprising a pressure sensor in communication with the vibration unit.

15. The device according to claim 12, further comprising a sensor operable to sense when the cooperating member is in the engaged position, the vibration unit being operable when the sensor senses that the cooperating member is in the engaged position.

16. The device according to claim 1, further comprising a biasing member operable to selectively bias the cooperating member towards the base member.

17. A method of removing excess fat from a portion of food, the method comprising the steps of:
providing a device comprising:
a base having a first surface;
a cooperating member having a second surface, the cooperating member having an open position wherein the second surface is spaced from the first surface and engaged position wherein the second surface is closer to the first surface and directed toward the first surface; and
a plurality of removable and replaceable fat absorbing sheets, each sheet having a food contacting face and an opposed back face, the sheets having a use position wherein the back face is disposed against the first surface of the base or the second surface of the cooperating member;
positioning the cooperating member in the open position;
placing a first one of the sheets in the use position on the base;
positioning a portion of food on the food contacting face of the first sheet;
placing a second one of the sheets between the portion of food and the cooperating member;
moving the cooperating member from the open position to the engaged position so as to squeeze the portion of food and remove excess fat from the portion of food.

18. The method of claim 17, further comprising the steps of providing a vibration unit and vibrating the portion of food.
